(19) United States
(12) Patent Application Publication
(10) Pub. No.: US 2008/0155926 A1
(43) Pub. Date: Jul. 3, 2008

(54) FOLDABLE STRUCTURES

(75) Inventor: Kongzhi Lu, Xiamen (CN)

Correspondence Address: AKIN GUMP STRAUSS HAUER & FELD, LLP, P O BOX 688, DALLAS, TX, 75313-0688, US

(73) Assignee: Xiamen Sunnypet Products, Co., Ltd., Xiamen (CN)

(21) Appl. No.: 11/737,323

(22) Filed: Apr. 19, 2007

(30) Foreign Application Priority Data
Dec. 27, 2006 (CN) 200620156628.1

(51) Int. Cl. E04B 1/343

(52) U.S. Cl. 52/478

(57) ABSTRACT

A foldable structure is disclosed. The foldable structure includes at least four frame members, and the number of frame members is even. A fabric material covers portions of each frame member to form a panel for each frame member. Each panel further has a left side and a right side, and the left side of each panel is connected and hinged to the right side of an adjacent panel, and the right side of each panel is connected and hinged to the left side of another adjacent panel, forming a ring of panels that encloses an interior space. The panels are folded to overlay each other.

The present invention claims foreign priority of Chinese patent application Number 200620156628.1, filed Dec. 27, 2006.

### TECHNICAL FIELD OF THE INVENTION

The present invention relates generally to foldable structures, and more particularly, to a foldable structure which may be provided in a variety of shapes and sizes.

### SUMMARY OF THE INVENTION

The present invention discloses a foldable structure comprising at least four frame members, but the number of frame members is even. A fabric material covers portions of each frame member to form a panel for each frame member. Each panel has a left side and a right side, and the left side of each panel is connected and hinged to the right side of an adjacent panel, and the right side of each panel is connected and hinged to the left side of another adjacent panel, forming a ring of panels that encloses an interior space. Moreover, the panels are folded to overlay each other.

The following description and drawings set forth in detail a number of illustrative embodiments of the invention. These embodiments are indicative of but a few of the various ways in which the present invention may be utilized.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a perspective cut-away view of a panel according to one embodiment of the present invention;

FIG. 2 is a perspective view of a foldable structure formed from eight panels according to the present invention; and

FIGS. 3 through 8 illustrate how the structure in FIG. 2 may be folded for compact storage according to the present invention.

### DETAILED DESCRIPTION OF THE INVENTION

The following discussion is presented to enable a person skilled in the art to make and use the invention. The general principles described herein may be applied to embodiments and applications other than those detailed below without departing from the spirit and scope of the present invention as defined herein. The present invention is not intended to be limited to the embodiments shown, but is to be accorded the widest scope consistent with the principles and features disclosed herein.

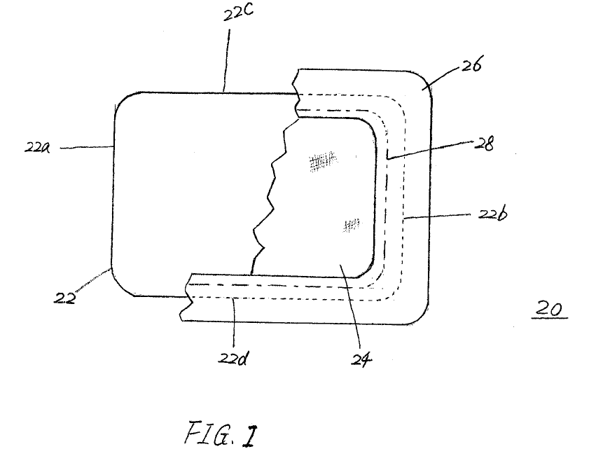

FIG. 1 illustrates an embodiment of a panel according to the present invention. The panel 20 has four sides: a left side 22a; a right side 22b; a top side 22c; and a bottom side 22d. The panel includes a frame member 22 to support the panel. The frame member 22 may be provided as one continuous loop, or may comprise a strip of material connected at both ends to form a continuous loop. Further, the frame member 22 may be formed of flexible metal, or other materials such as plastics. However, the frame member 22 should be made of a material that is relative strong to support the panel 20.

In addition, fabric or sheet material 24 may extend across the panel 20. Moreover, the fabric 24 is held taut by the frame member 22. The fabric 24 may extend completely across the panel 20 to entirely cover the enclosed space defined by the frame member 22. The term fabric is to be given its broadest meaning and should be made from strong, lightweight materials, and may include woven fabrics, sheet fabrics or even films. Additionally, the fabric 24 may be water-resistant and durable to withstand wear and tear. Further, the type of material used for the fabric 24 may be varied depending on the intended use.

A continuous frame retaining sleeve 26 is provided along, and traversing the frame member 22 to retain or hold the frame member 22. In addition, the frame member 22 may be merely retained within the frame retaining sleeve 26 without being connected thereto. Alternatively, the frame retaining sleeves 26 may be mechanically fastened, stitched, fused or glued to the frame member 22, to retain the frame member 22 in position. The frame retaining sleeve 26 may be made of, but not limited to, fabric, or plastic.

Moreover, the frame retaining sleeve 26 may be formed by merely folding a piece of fabric over the frame member 22, and applying a stitching 28. Then the frame retaining sleeve 26 is connected to fabric 24 by stitching, or other applicable means. Alternatively, the frame retaining sleeve 26 may be formed by folding the fabric 24 over the frame member 22 and then applying the stitching 28.

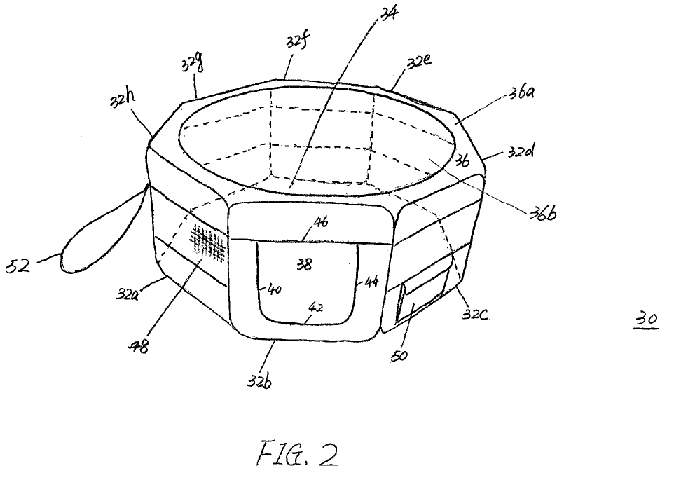

FIG. 2 illustrates an embodiment of a foldable structure 30 that utilizes a plurality of panels 20. Structure 30 comprises 8 side panels 32a, 32b, 32c, 32d, 32e, 32f, 32g and 32h that are connected to each other to form an enclosed space. Each of these side panels 32a, 32b, 32c, 32d, 32e, 32f, 32g and 32h is defined by a panel 20. The right side of each of these side panels is hingedly connected to the left side of an adjacent side panel. Additionally, the left side of each of these side panels is hingedly connected to the right side of another adjacent side panel. A hinged connection of any two adjacent side panels may be made by connecting the two adjacent sides of the two adjacent side panels together, such that the two adjacent side panels may be folded about the connection hinge. For example, side panel 32a and side panel 32b is hingedly connected by stitching the frame retaining sleeve of the right side of side panel 32a to the frame retaining sleeve of the left side of side panel 32b. Thus, side panel 32a and 32b may be folded upon each other about the stitching which acts as a hinge. Other hinged connection mechanisms may also be used without departing from the spirit and scope of the present invention.

A floor portion 34 which may be made from the same material as the fabric 24 may be provided to interconnect the bottom side of each of the side panels 32a, 32b, 32c, 32d, 32e, 32f, 32g and 32h.

The structure 30 may further include a roof 36, which may be made of the same material as the fabric 24. The roof 36 includes two portions 36a and 36b. Roof portion 36a is interconnected with the top side of each of the side panels 32a, 32b, 32c, 32d, 32e, 32f, 32g and 32h. Roof portion 36b may be a round-shaped cut-out and may also be removable. Roof portion 36a and 36b may be connected by any connecting means. For example, roof portions 36a and 36b may be zipped together.

The structure 30 may include a door, preferably located in one of the side panels. For example, a door 48 may be included in side panel 32b for ingress and egress. The door 48 is essentially a rectangular-shaped cut-out in the side panel 32b, and may be made of a fly-screen. Alternatively, the door may also have just a portion of it made of fly-screen. The door 48 has three zipper edges 40, 42 and 44, and a hinged edge 46. However, there may be more than one door, located in one or more side panels.

Ventilation of the structure 30 may be achieved by providing a mesh portion on any or all of the side panels 32a, 32b, 32c, 32d, 32e, 32f, 32g and 32h. For example, side panel 32a has a mesh portion 48. In addition, small pockets may be provided outside any side panel. For example, a pocket 50 is provided on side panel 32c. A strap 52 may also be provided for binding the side panels together after the structure 30 is folded and collapsed.

The structure 30 may be folded and stored by folding the side panels and their corresponding frame members on top of each other about the hinge portion to have the side panels and frame members overlying each other.

FIGS. 3-8 describe various steps for folding and collapsing the structure of the embodiment in FIG. 2 for storage or carry. In FIG. 3, the first step consists of pushing in side panel 32a against side panel 32h in the direction of arrow A1, such that side panel 32a and 32h are folded upon each other.

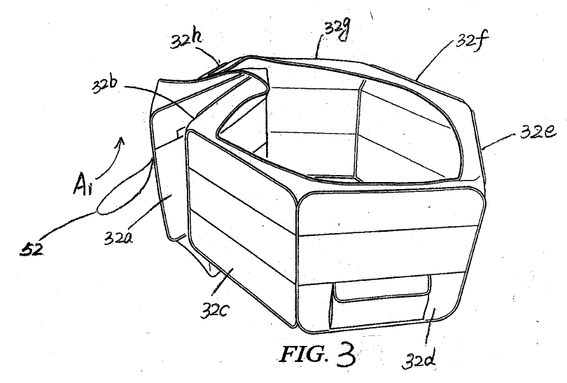

Then in FIG. 4, side panel 32g is pushed in against side panel 32b in the direction of arrow A2, so that side panel 32g collapses upon side panel 32b.

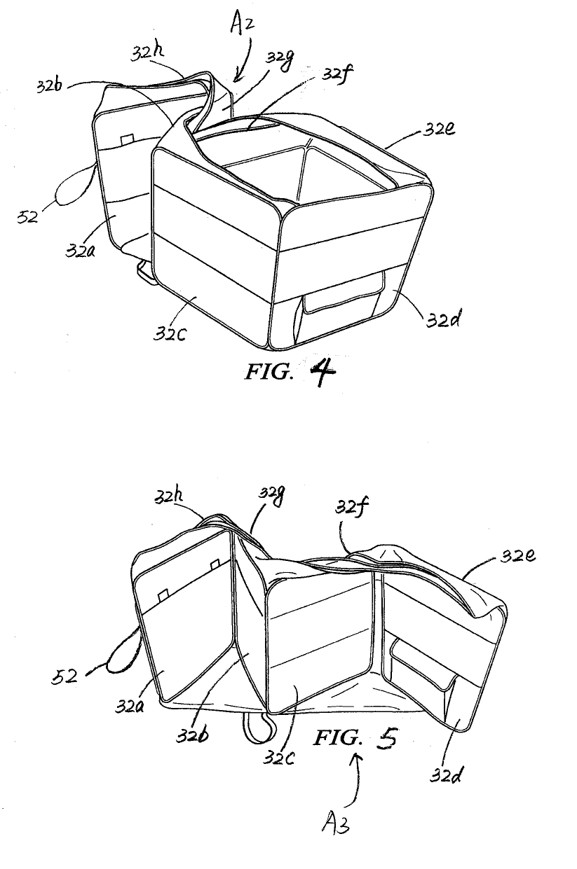

Then in FIG. 5, side panels 32c and 32d are pushed in against side panels 32f and 32e, respectively, about the hinges, in the direction of arrow A3, so that side panels 32c collapses upon side panel 32f, and side panels 32d collapses upon side panel 32e.

The combined side panels 32a and 32h, 32b and 32g, 32c and 32f, and 32d and 32e are folded against each other about the hinges to form one stack of panels 32h, 32a, 32b, 32g, 32f, 32c, 32d and 32e, in one possible order, as illustrated in FIG. 6.

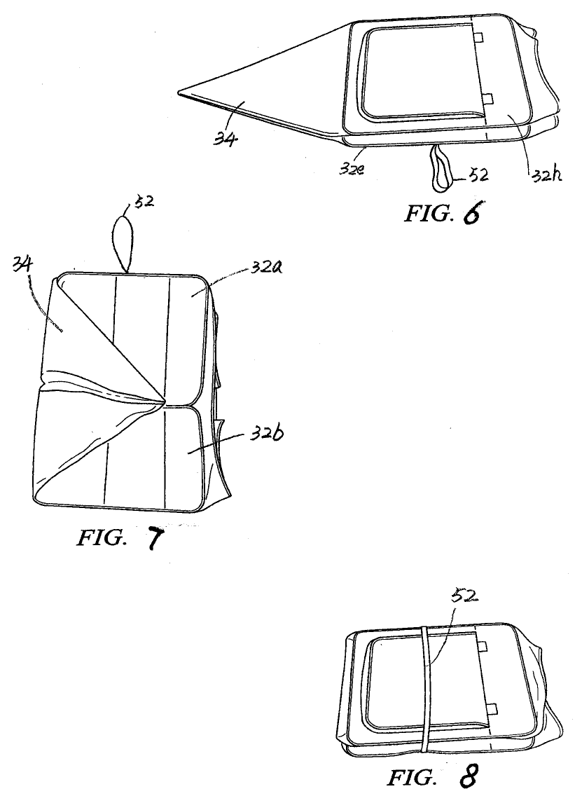

The floor fabric 34 may be adjusted to make a triangle shape. The floor fabric 34 may then be folded over against side panels 32a and 32b, as illustrated in FIG. 7.

In FIG. 8, the stack of side panels is bound by the strap 52. A structure such as structure 30, may be conveniently folded and collapsed, thereby making it convenient to carry and move around, and requiring little storage space. The structure may be used as a pet house, indoor or outdoor.

A foldable structure, such as structure 30, may include any even number of side panels, without departing from the spirit and scope of the present invention. For example, a foldable structure may have 6, or 10 side panels. More side panels provide a wider enclosed space for the foldable structure, but still keeps the advantage of easy collapsing and storage. Each side panel of the structure, regardless of its shape, is supported by at least one continuous frame member.

The previous description of the disclosed embodiments is provided to enable those skilled in the art to make or use the present invention. Various modifications to these embodiments will be readily apparent to those skilled in the art and generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A foldable structure, comprising:
at least four frame members, wherein the number of frame members is even; and
a fabric material covering portions of each frame member to form a panel for each frame member, wherein each panel further has a left side and a right side, and
the left side of each panel is connected and hinged to the right side of an adjacent panel, and the right side of each panel is connected and hinged to the left side of another adjacent panel, forming a ring of panels enclosing an interior space, and the panels are folded to overlay each other.

2. The foldable structure of claim 1, wherein each panel includes a frame retaining sleeve for retaining the frame member, and the frame retaining sleeves of adjacent sides of adjacent panels are connected together to form a hinged connection.

3. The foldable structure of claim 2, wherein the frame retaining sleeves of adjacent sides of adjacent panels are stitched together to form a hinged connection.

4. The foldable structure of claim 1, wherein each panel includes a bottom side, and a fabric material interconnecting the bottom side of each of the panels.

5. The foldable structure of claim 1, wherein each panel includes a top side, and a fabric material interconnecting the top side of each of the panels.

6. The foldable structure of claim 5, wherein the fabric material includes a removable portion.

7. The foldable structure of claim 1, wherein a binding means is provided to bind the panels together after the panels are folded upon each other.

8. The foldable structure of claim 1, wherein at least one door is provided in any of the panels.

9. The foldable structure of claim 8, wherein the at least one door has a mesh portion.

10. The foldable structure of claim 1, wherein at least one of the panels has a mesh portion.

11. A foldable structure, comprising:
eight frame members;
a fabric material covering portions of each frame member to form a panel for each frame member, each panel further having a left side, a right side, a top side and a bottom side;
wherein the left side of each panel is connected and hinged to the right side of an adjacent panel, and the right side of each panel is connected and hinged to the left side of another adjacent panel, forming a ring of panels enclosing an interior space; and
a first fabric material is provided interconnecting the bottom side of each of the panels;
a second fabric material is provided interconnecting the top side of each of the panels, and the second fabric material comprises a removable portion; and
the panels are folded to overlay each other.

12. The foldable structure of claim 11, wherein each panel comprises a frame retaining sleeve for retaining the frame member, and the frame retaining sleeves of adjacent sides of adjacent panels are stitched together to form a hinged connection.

13. The foldable structure of claim 11, wherein at least one door is provided in any of the panels.
